(19) United States
(12) Patent Application Publication
(10) Pub. No.: US 2016/0112369 A1
(43) Pub. Date: Apr. 21, 2016

(54) System and Method for Validating a Customer Phone Number

(71) Applicant: Michael Boodaei, Givatayim (IL)

(72) Inventor: Michael Boodaei, Givatayim (IL)

(21) Appl. No.: 14/919,492

(22) Filed: Oct. 21, 2015

Related U.S. Application Data
(60) Provisional application No. 62/066,385, filed on Oct. 21, 2014.

(51) Int. Cl. H04L 29/12; H04M 1/272

(52) U.S. Cl. CPC H04L 61/1594; H04M 1/2725

(57) ABSTRACT

The invention relates to a system for validating a pair of phone number and person's name, which comprises: (a) a logical unit at a provider's server which is configured to receive said pair, and to determine based on a number of full matches or partial matches of said pair within as many as possible individual contact lists of respective mobile devices whether the pair is valid or not; and (b) a module within each provider's application which are in turn installed within each of said mobile devices, said module is configured to communicate with the respective contact list stored in the mobile, and to (a) either communicate said full contact list to said provider's server, or (b) to determine whether a full or partial match exists with said pair, and to communicate the determined result to said provider's server.

### CROSS-REFERENCE TO RELATED APPLICATIONS

This application claims the benefit of U.S. Provisional Application No. 62/066,385 filed Oct. 21, 2014, which is hereby incorporated by reference in its entity.

### FIELD OF INVENTION

The invention relates in general to the field of identity validation of customers within a computerized environment such as the e-commerce environment.

### BACKGROUND OF THE INVENTION

The mobile telephone number has become a major tool for a personal identification. People having a mobile telephone number rarely replace this number, in view of the complexity involved in notifying all their contact persons and institutes with respect to this change. In many cases, a person can maintain a same mobile number even when transferring from one telephone supplier to another. Therefore, the correlation of mobile phone numbers with customer identities is often used for security and fraud prevention purposes. A service provider such as a financial institution or goods supplier in an e-commerce may contact a customer over the customer's mobile phone to approve sensitive operations such as payments and money transfers. As a result fraudsters often try to register a phone number they have access to under the customer's account so that any validation call, text message, or notification that the service provider sends to the customer will reach the fraudster instead. Registering a fraudulent phone number under a customer's account can be done through various channels such as through a phishing attack in which the fraudster steals the customer's login credentials to the service provider's website and use these credentials to log into the website and change the customer's contact information.

When a new phone number is added to a customer's profile, the service provider typically wishes to check whether this phone really belongs to the identified customer. One of the options available today is consulting with the customer's mobile operator. However, many mobile operators do not provide this information or just do not have accurate information (for example when the mobile phone is registered on behalf of a work place). Another option is to contact the customer himself via a different channel (home phone number, email, mail address etc.) for validation. But this procedure usually takes time, is inconvenient to the customer, and complex for the service provider.

It is therefore an object of the invention to provide a system and method for validating the mobile telephone number of a customer. More specifically, it is an object of the invention to verify whether a given phone number indeed belongs to the person's name which is associated with it.

It is another object of the invention to perform said verification in an automatic manner.

It is still another object of the invention to perform such verification in a high degree of certainty.

Other objects and advantages of the invention will become apparent as the description proceeds.

### SUMMARY OF THE INVENTION

The invention relates to a system for validating a pair of phone number and person's name, which comprises: (a) a logical unit at a provider's server which is configured to receive said pair, and to determine based on a number of full matches or partial matches of said pair within as many as possible individual contact lists of respective mobile devices whether the pair is valid or not; and (b) a module within each provider's application which are in turn installed within each of said mobile devices, said module is configured to communicate with the respective contact list stored in the mobile, and to (a) either communicate said full contact list to said provider's server, or (b) to determine whether a full or partial match exists with said pair, and to communicate the determined result to said provider's server.

In an embodiment of the invention, (a) said module at each of the applications applies a cryptographic hash function on said full contact list prior to sending it to the provider's server; (b) all said hashed contact lists that are communicated to the provider's server are accumulated to form a global list in hashed form; (c) said logical unit at the provider's server is configured to first apply a server's hash function on the pair to be validated, prior to determining the number of full matches or partial matches of said hashed pair within said hashed global contact list, and wherein said server hash function and said application hash function are the same function.

In an embodiment of the invention, the provider's server further comprises an evaluation module for evaluating a probability score for the validation result.

In an embodiment of the invention, said score is based on information selected from: (a) number of full matches between the hashed pair and the hashed global list; (b) number of partial matches between the hashed pair and the hashed global list; (c) the earliest date of storage of each of said full matches and said partial matches within the global contact list.

In an embodiment of the invention, (a) each of said modules within each provider's application is configure to receive said pair from the provider's server, to verify the number of full and the number of partial matches in the contact list of the device, and to report said verification result to said logical unit at the provider's server; (b) and said logical unit at the provider's server accumulates the reported verification results from as many as possible of said devices respectively, and based on all said reports calculates the validity of said pair.

The invention also relates to a method for validating by a provider's server a pair of person's name and his phone number, comprising: (a) comparing said pair with as many as possible contact lists that are stored at plurality of mobile devices, respectively, thereby to obtain the total number of full matches and the total number of partial matches, as appear in all said contact lists; and (b) determining a probability for the validation of said pair based on said obtained full and partial matches.

In an embodiment of the invention, said steps of comparison and validity determination are performed on a global contacts list at the provider's server, following performance of the following steps: (a) extracting by a provider's application which is installed at each mobile device, respectively, a copy of the individual contact list which is stored at that device; (b) transforming each of said copies of individual contact lists into a hashed form by an application hash function, respectively in each device, and sending said individual contact list in a hashed form to said provider's server; (c) at the provider's server, combining all said copies of individual lists in a hashed form into a global contact list in a hashed form; and (d) transforming the pair which is to be validated into a hashed form by a server hash function which is identical to said application hash function, and performing said comparison and validity determination between said pair in a hashed form and said global contact list in a hashed form.

In an embodiment of the invention, said validity determination further takes into account the earliest date in which each full matched or partial matched pair was stored within the global contact list.

In an embodiment of the invention, said global list is periodically updated by periodically repeating the steps of extracting, transforming at the individual device, sending into the provider's server, and combining into the global list.

A method according to claim 7, wherein each repeated sending of a contact list from a mobile device into the server may involve sending of only updates, not a full contact list.

In an embodiment of the invention, the method further comprises: (a) sending the pair for validation into a provider's application at the as many as possible mobile devices; (b) at each mobile device, comparing said pair with the individual contact list at that device to determine whether a full match or partial match exists, and reporting the results of said comparison to said provider's server; (c) at the provider's server, accumulating the comparison reports from all said mobile devices; and (d) performing said determination of the probability validation on said accumulation of all reports.

### BRIEF DESCRIPTION OF THE DRAWINGS

In the drawings:

FIG. 1 shows a typical prior art situation where a provider distributes an application, a copy of which is installed within each customer mobile device (such as smart phone);

FIG. 2 illustrates the system structure according to a first embodiment of the invention;

FIG. 3 illustrates the above validation process of FIG. 2 in more details; and

FIG. 4 shows another embodiment of the invention.

### DETAILED DESCRIPTION OF PREFERRED EMBODIMENTS OF THE INVENTION

The present invention provides a risk-based method and system for correlating between a given customer name and a phone number. Using this method and system, a service provider can determine the likelihood of a certain phone number to be used by a certain customer. The invention utilizes the assumption that a valid pair of a person's name and a corresponding phone number should appear within a relatively large number (at least several tens) of contact lists, each list being stored within another mobile phone, respectively. Therefore, an inspection within a large number of such checking lists (thousands or more) should reveal, or at least indicate in a relatively high certainty whether the pair is valid or not (hereinafter, the term “valid pair” indicates that the phone number really corresponds to the person name connected to it. The more people having a given person and phone number (i.e., pair”) listed in their contact list, the higher likelihood that this pair is valid, i.e., the phone number actually belongs to this given person name. The invention discloses several procedures for performing such a verification, with substantially no or minimal impact on the customer's privacy or security.

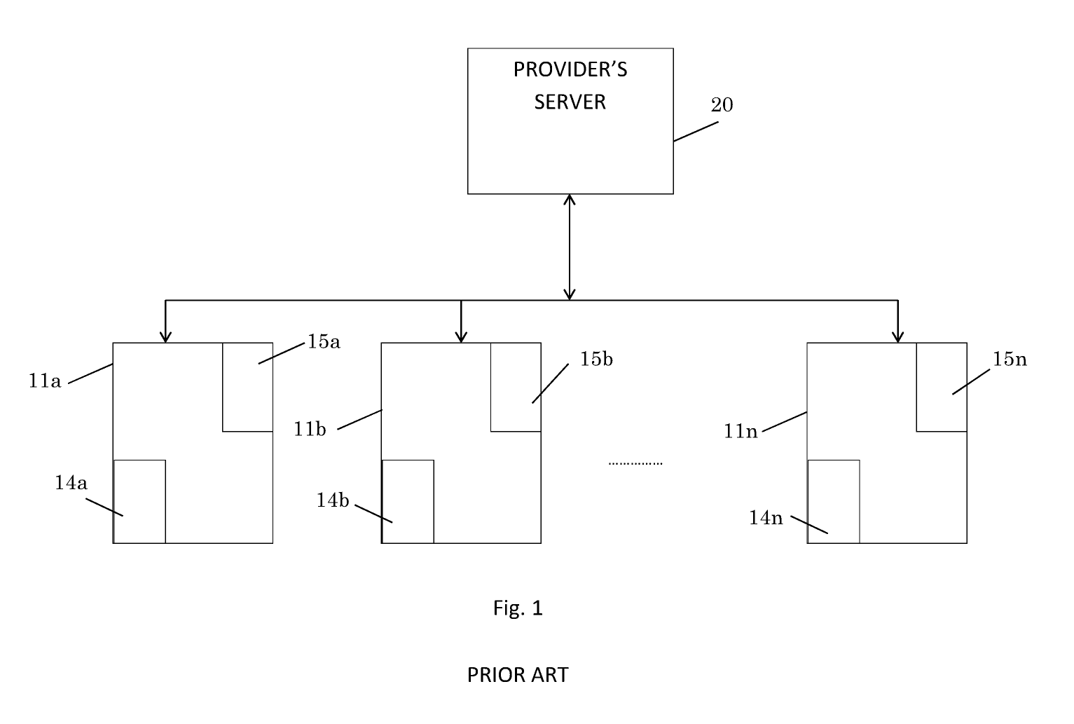

FIG. 1 shows a very typical prior art situation where a provider (such as a financial institution, an e-commerce seller or service provider, etc.) distributes (for example, via an App Store) an application 15, a copy of which is installed within each customer mobile device 11 (such as smart phone). For example, a bank typically distributes such an application to his customers for installation within their mobile devices, respectively. Such a bank application enables the respective customer to access the bank server 20 by means of application 15, to download or view information relating to his bank account, to submit orders to the bank, to view his credit card status, to perform transactions, etc. A huge number of such applications already exist in the market. As will be elaborated, the invention utilizes such an application for the purpose of validating a given pair, i.e., matching between a given phone number and a person's name.

As is also standard, each mobile device contains a “contact list” 14a-14n of all persons and institutions that the user is in normal contact with. Typically, each of such lists contains hundreds or even thousands of pairs of a person name and phone number.

Many typical applications 15 (of various types and natures) condition the application installation with the user agreement to grant access to his contact list 14, even if this access to the list is not really necessary for the normal operation of the application (at least from the view point of the user). For example, upon installation of a newspaper application or even a game application it is not uncommon that the user is requested to grant the application access his contact list. Just for example, the installation of the Android version of the Google Apps is conditioned by the user agreement to grant the application a right to “modify your contacts” and to “read your contacts”.

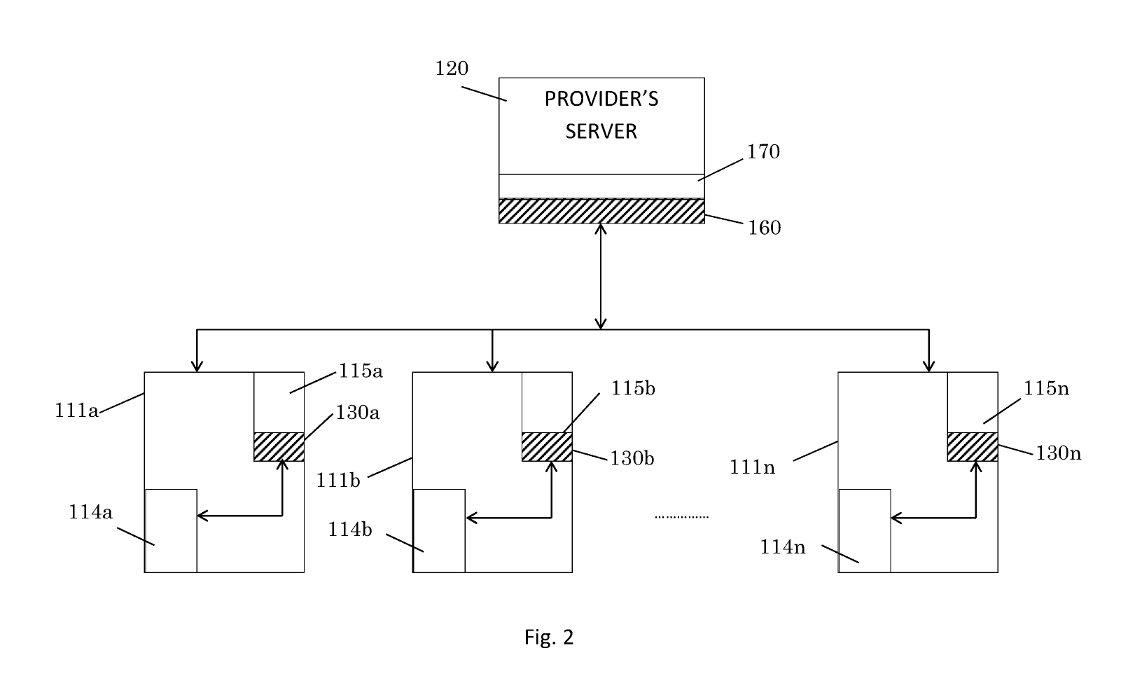

FIG. 2 illustrates the system structure according to a first embodiment of the invention. Each of the provider's applications 115 in the device (the provider may be any institution, for example, a bank, that needs to validate a pair), in addition to its normal functionality, comprises a list extracting and communicating module 130. Module 130, within each device 115, accesses the contact list 114 of the respective device, extracts a copy the full contact list, applies on it a one-way cryptographic hash function, and transmits the hash values (digest) to database 160 within the provider's server 120. A one-way cryptographic hash function is considered practically impossible to invert, that is, to recreate the input data from its hash value alone. Therefore, even if someone gains access to the database, there is no way of getting phone numbers and contact information out of the stored digest. Then, module 130 within each device 111 sends the digest to the provider's database 160. The database 160 accumulates all the lists from the plurality of devices 111 (typically tens of thousands and up to hundreds of thousands or more of such lists), thereby forming a global list, with an indication of the total number of appearances of each specific pair within the various lists. Upon a necessity to verify the validity of a “pair” (again, phone number and person's name), a logical unit 170 within the provider's server 120 first applies the same hash function as applied within the devices 111 on the pair in question, then logical unit 170 verifies whether the hashed pair in question appears within the global database 160, and if so, how many appearances of such pair exist. Of course, the more appearances of the pair are found, the likelihood for the validity of the pair is increased. Logical unit 170 evaluates this validity based on some predefined rules.

Preferably, the extraction and transmission of the full contact lists to the provider's server is performed periodically, for example, once every two months. Once a list was transferred to the database 160, the next transmissions of the same list may include only updates to the list, not the full list.

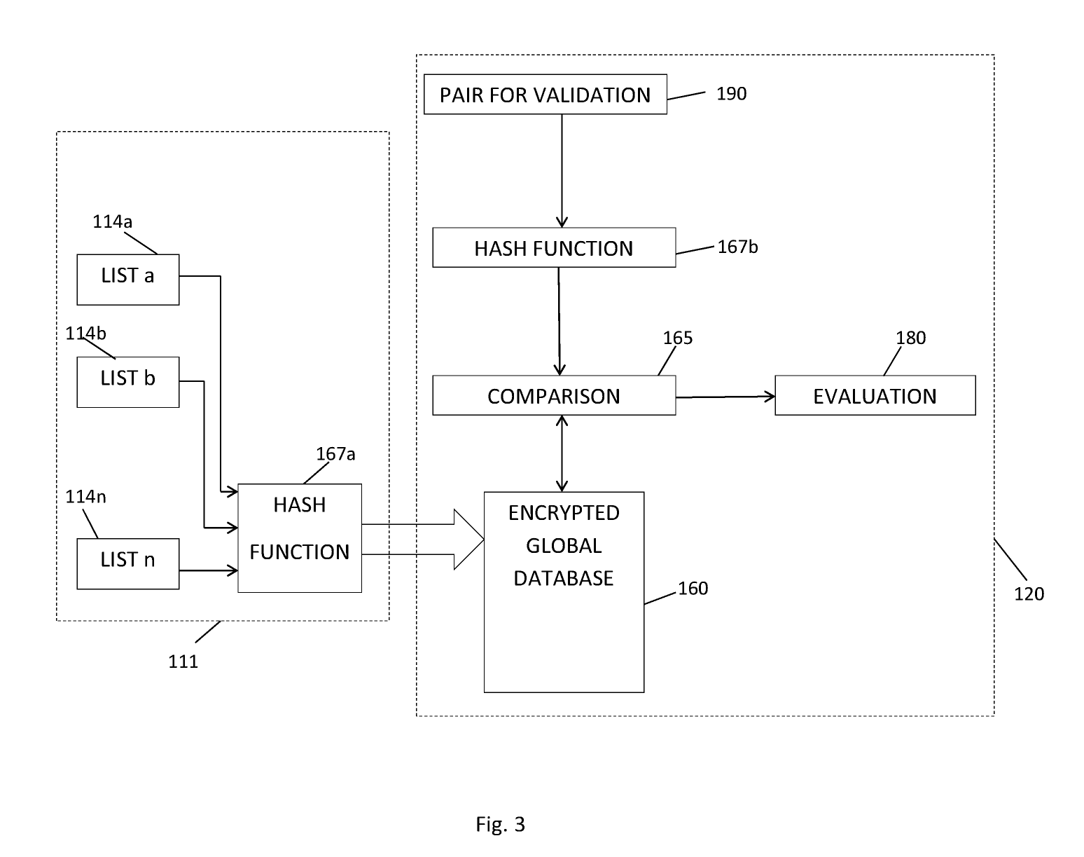

FIG. 3 illustrates the above validation process of FIG. 2 in more details. Contact lists 114 are periodically hashed by hash function 167a, and then transferred to the global database 160 at the provider's server. When a necessity arises to validate a pair 190, the pair is subjected to a hash function 167b, which is in fact identical to hash function 167a at the application. The hashed pair is then compared by comparison unit 165 with the global database 160 to determine the number of appearances. The number of appearances, and potentially additional parameters (that will be discussed hereinafter) are conveyed to the evaluation unit 180, that may calculate a “score” for the validity of the pair 190.

### EXAMPLE

For example, a validation of a pair may involve the following procedure:
a. The mobile application 115 accesses the contact list 114 at the mobile device;
b. For each contact in the contact list the mobile application creates by hash function 167a a one-way hash of the name and the phone number listed for this contact;
c. The mobile application sends these one way hashed pairs to the server 120 together with a unique random identifier for the specific mobile device from which the information was collected;
d. The server runs a database 160 of all the hashed contacts collected from all the different devices 111. Each entry in the database includes the hashed name of the contact, the hashed phone number of the contact, a list of devices that has a match for this contact and phone number, and the time on which this contact was collected from each one of these devices;
e. The list of devices is required so that a single device will not be counted twice, and also when the extraction date of the pair is to be considered;
f. The database can be collected per service provider, or alternatively, several service providers may choose to share databases in order to increase the sample size.

Risk assessment flow:
1. When the provider gets a pair of a name and phone number that requires validation, the provider creates the one way hash 167b of the name and phone number;
2. The provider then searches the hashed database 160 for a matching name and/or phone number; When a match is found, a risk is calculated based on the following attributes in the database:
   a. Does the hash of the phone number in the database matches the hash of the phone number and/or name and/or pair that is searched?
   b. How many different devices have reported this match?
   c. How many different devices have reported a mismatch, meaning that they either have a different phone hash of this customer name or have a different customer name for this phone hash;
   d. How old are these records in the database 160?
3. The risk is then calculated based on a formula that the service provider can set. For example:
   a. RISK is LOW if exact match is found in at least 5 different devices, mismatch is found in less than 10 devices, and the oldest match is at least 12 months old.
   b. RISK is HIGH if exact match is found in one or less devices and this match is less than 10 days old and a mismatch is found in more than 5 devices.

As shown, the security and privacy of the owners of the mobile phones are maintained, as the contact list 114 from each of the devices is transferred to the global database 160 in a hashed (one-way cryptographic function) form. The hashed global database cannot reveal any of the original individual pairs, but still can be used for the pair validation purpose of the invention.

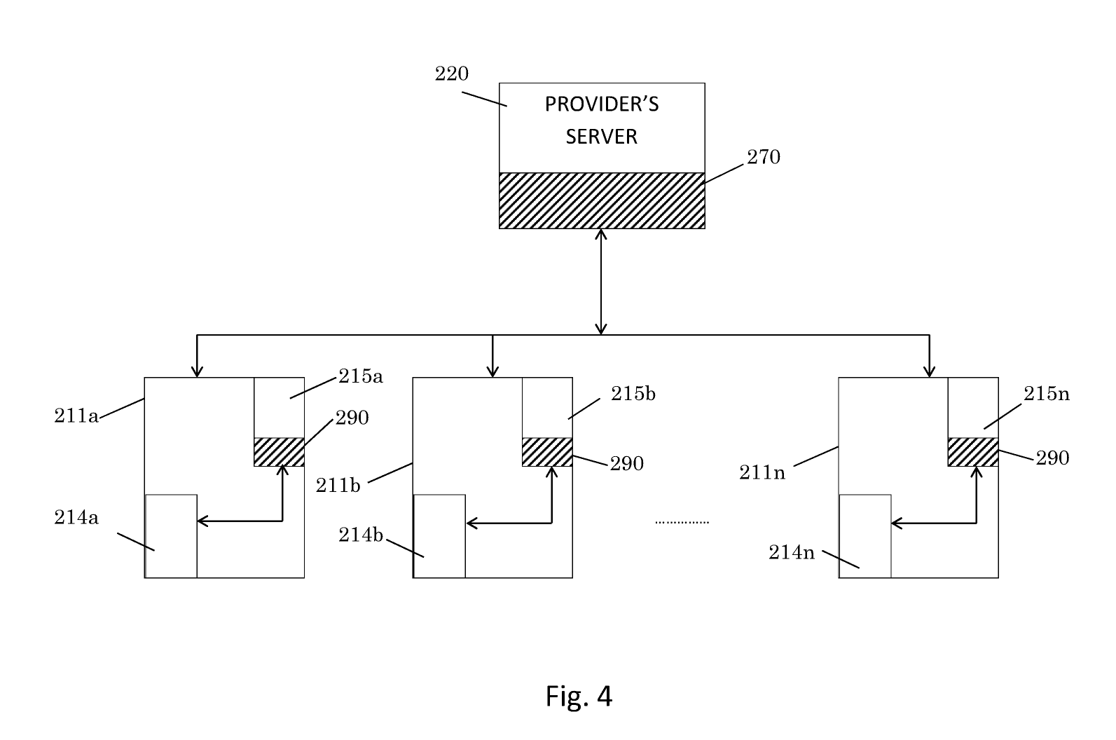

FIG. 4 shows still another embodiment of the invention. Upon a need for a validation of a pair, logical unit 270 distributes the pair in question to the mobile applications 215, respectively, in all the devices 211. A verification unit 290 within each of the applications 215 scans the local contact list 214 for a possible full match of the entire pair, and/or a partial match of a phone number only, or a name only. The result of each individual scan is thereafter conveyed from each respective mobile device to the logical unit 270 at the provider's server 220. The provider's server collects the results from as many as possible devices, and evaluates a score based on the number of matches, or number of partial matches that are found.

While some embodiments of the invention have been described by way of illustration, it will be apparent that the invention can be carried out with many modifications variations and adaptations, and with the use of numerous equivalents or alternative solutions that are within the scope of persons skilled in the art, without departing from the spirit of the invention or exceeding the scope of the claims.

What is claimed is:

1. A system for validating a pair of phone number and person's name, which comprises:
a. a logical unit at a provider's server which is configured to receive said pair, and to determine based on a number of full matches or partial matches of said pair within as many as possible individual contact lists of respective mobile devices whether the pair is valid or not; and
b. a module within each provider's application which are in turn installed within each of said mobile devices, said module is configured to communicate with the respective contact list stored in the mobile, and to (a) either communicate said full contact list to said provider's server, or (b) to determine whether a full or partial match exists with said pair, and to communicate the determined result to said provider's server.

2. A system according to claim 1, wherein:
a. said module at each of the applications applies a cryptographic hash function on said full contact list prior to sending it to the provider's server;
b. all said hashed contact lists that are communicated to the provider's server are accumulated to form a global list in hashed form;
c. said logical unit at the provider's server is configured to first apply a server's hash function on the pair to be validated, prior to determining the number of full matches or partial matches of said hashed pair within said hashed global contact list, and wherein said server hash function and said application hash function are the same function.

3. A system according to claim 2, wherein the provider's server further comprises an evaluation module for evaluating a probability score for the validation result.

4. A system according to claim 3, wherein said score is based on information selected from:
a. number of full matches between the hashed pair and the hashed global list;
b. number of partial matches between the hashed pair and the hashed global list;
c. the earliest date of storage of each of said full matches and said partial matches within the global contact list.

5. A system according to claim 1, wherein:
a. each of said modules within each provider's application is configure to receive said pair from the provider's server, to verify the number of full and the number of partial matches in the contact list of the device, and to report said verification result to said logical unit at the provider's server; and
b. said logical unit at the provider's server accumulates the reported verification results from as many as possible of said devices respectively, and based on all said reports calculates the validity of said pair.

6. Method for validating by a provider's server a pair of person's name and his phone number, comprising:
a. comparing said pair with as many as possible contact lists that are stored at plurality of mobile devices, respectively, thereby to obtain the total number of full matches and the total number of partial matches, as appear in all said contact lists; and
b. determining a probability for the validation of said pair based on said obtained full and partial matches.

7. Method according to claim 6, wherein said steps of comparison and validity determination are performed on a global contacts list at the provider's server, following performance of the following steps:
a. extracting by a provider's application which is installed at each mobile device, respectively, a copy of the individual contact list which is stored at that device;
b. transforming each of said copies of individual contact lists into a hashed form by an application hash function, respectively in each device, and sending said individual contact list in a hashed form to said provider's server;
c. at the provider's server, combining all said copies of individual lists in a hashed form into a global contact list in a hashed form; and
d. transforming the pair which is to be validated into a hashed form by a server hash function which is identical to said application hash function, and performing said comparison and validity determination between said pair in a hashed form and said global contact list in a hashed form.

8. A method according to claim 7, wherein said validity determination further takes into account the earliest date in which each full matched or partial matched pair was stored within the global contact list.

9. A method according to claim 7, wherein said global list is periodically updated by periodically repeating the steps of extracting, transforming at the individual device, sending into the provider's server, and combining into the global list.

10. A method according to claim 7, wherein each repeated sending of a contact list from a mobile device into the server may involve sending of only updates, not a full contact list.

11. A method according to claim 6, which comprising:
a. sending the pair for validation into a provider's application at the as many as possible mobile devices;
b. at each mobile device, comparing said pair with the individual contact list at that device to determine whether a full match or partial match exists, and reporting the results of said comparison to said provider's server;
c. at the provider's server, accumulating the comparison reports from all said mobile devices; and
d. performing said determination of the probability validation on said accumulation of all reports.
